(19) United States
(12) Patent Application Publication
(10) Pub. No.: US 2008/0102776 A1
(43) Pub. Date: May 1, 2008

(54) Antenna for a Radio Base Station in a Mobile Cellular Telephony Network

(75) Inventors: Sven Petersson, Savedalen (SE); Martin Johansson, Molndal (SE); Anders Derneryd, Goteborg (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/722,960

(22) PCT Filed: Dec. 30, 2004
(86) PCT No.: PCT/SE04/02039

§ 371 Date: Jun. 27, 2007

(51) Int. Cl. H04B 7/00

(52) U.S. Cl. 455/276.1

(57) ABSTRACT

An antenna device for a radio base station in a mobile cellular telephony network. The device includes a first sub-antenna with a first feed network for distributing signals within the first sub-antenna, and a second sub-antenna with a second feed network for distributing signals within the second sub-antenna. The first and second feed networks are connected to a common main feed network, thus providing the device with a single feed port. A first controller controls one or both of the sub-antennas, and may introduce time delays in signals being transmitted or received by one or both of the sub-antennas. The device may also include a second controller for controlling the common main feed network.

### TECHNICAL FIELD

The present invention discloses an antenna device for a radio base station in a mobile cellular telephony network, comprising a first sub-antenna with a first feed network for distributing signals within the first sub-antenna.

### BACKGROUND ART

In cellular telephony systems, there is often a need to cover a wide range of different environments and surroundings, such as urban and suburban environments as well as, for example, less populated areas, for example areas along highways.

Conventional site installations in cellular telephony systems typically utilize two antennas per cell on uplink, and one on downlink. In some cases, different antennas are used for uplink and downlink, but normally both transmission directions utilize the same antennas. In some cases, two antennas are used for downlink as well. Antennas for a certain site are selected with respect to parameters such as gain, beam width, side lobe-levels etc.

The antennas may be installed in such a way that the beam(s) are given a tilt by means of the mechanical installation, or the antenna beams may be given a tilt in a desired direction by means of electrical steering.

However, existing families of antennas offer only a limited number of parameter variations. As a result, some site installations do not give the desired coverage and exhibit other undesired effects, for example low isolation between cells.

### DISCLOSURE OF THE INVENTION

As described above, there is thus a need for an antenna or antenna device for a radio base station in a cellular telephony system that could offer greater flexibility in varying the radiation pattern or coverage of the cell than known antennas.

This need is addressed by the present invention in that it discloses an antenna device for a radio base station in a mobile cellular telephony network, comprising a first sub-antenna with a first feed network for distributing signals within the first sub-antenna.

The antenna device also comprises a second sub-antenna with a second feed network for distributing signals within the second sub-antenna. The first and second feed networks are connected to a common main feed network, thus providing the antenna device with a single feed port.

The device of the invention also comprises control means for control of at least one of the sub-antennas.

Suitably, the antenna device may additionally comprise means for introducing a time delay in signals that are transmitted or received by at least one of the first and second sub-antennas.

The control means may be used for distributing control signals within the antenna device to one or more of the sub-antennas. Examples of what can be controlled are the time delay mentioned above, as well as, for example, electrical steering of one of the sub-antennas which is electrically steerable, or, where applicable, the relative power distribution between the sub-antennas.

The main feed network of the antenna device can be implemented in different fashions. One such implementation is of the parallel type, where the sub-antennas are fed in parallel. Another implementation of the main feed network is of the serial type, where one of the sub-antennas is equipped with two RF-ports, one of which is used for connection towards the base station, while the other is connected to the other sub-antenna.

By virtue of the fact that the common main feed network gives the device of the invention a single RF-port towards the radio base station, the base station equipment can treat the device as one single antenna, meaning that no changes need to be made in the base station, which naturally is an advantage.

If necessary, the antenna device of the invention may include more sub-antennas than the first and second sub-antennas mentioned above, but throughout this description, the device of the invention will be described as comprising two sub-antennas. It can be pointed out that each of the sub-antennas comprised in the device of the invention can be designed as a conventional antenna used in radio base stations.

As mentioned, the antenna device may be used for generating a desired coverage of a cell. Thus, the first sub-antenna may be equipped with means for electrical tilting of the beam, and can be used for covering the outer parts of the cell, while the second sub-antenna is used for covering the vicinity of the base station.

As an additional example, in urban areas, where the antennas are installed on rooftops, the coverage at street level close to the antenna may be poor due to large propagation loss, although the distance to the antenna may be short. This problem can be overcome by directing the second sub-antenna towards the area suffering from the large propagation loss.

To avoid undesired interaction between the sub-antennas of the device, the different sub-antennas can have different polarizations, different path (time) delays, or sufficient spatial separation.

### BRIEF DESCRIPTION OF THE DRAWINGS

The invention will be described in more detail in the following, with reference to the appended drawings, in which

FIG. 1 shows a first embodiment of an antenna device of the invention, and

FIGS. 2 and 3 show alternative embodiments of an antenna device of the invention.

### EMBODIMENTS

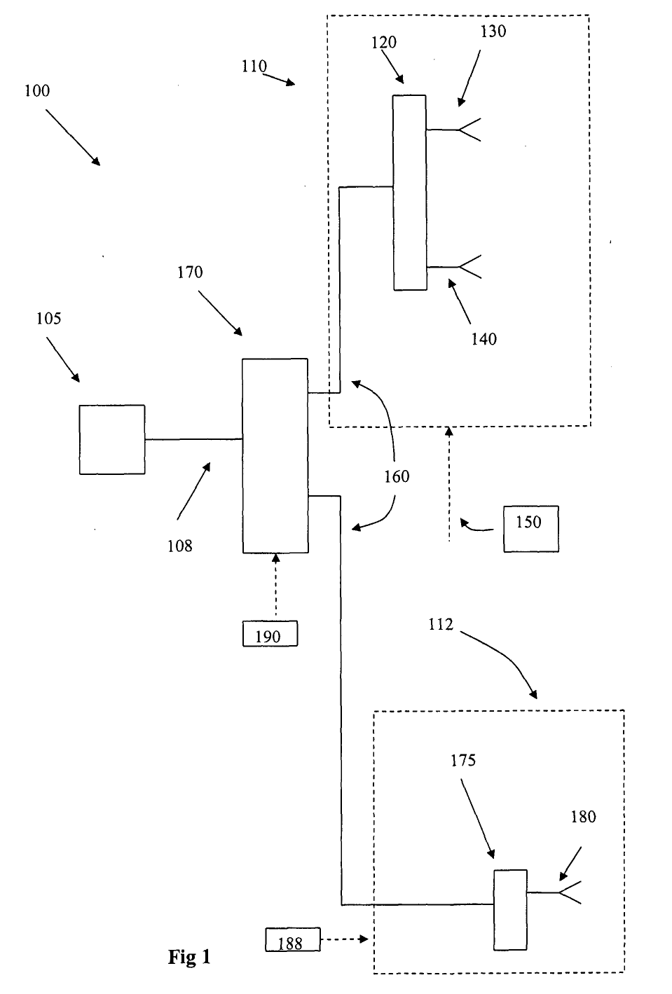

In FIG. 1, a first embodiment 100 of an antenna device of the invention is shown schematically. As shown in FIG. 1, the device 100 is intended to be connected to a radio base station 105 in a cellular telephony network.

The device 100 comprises a first 110 and a second 112 antenna, which may also be seen as “sub-antennas” within one and the same antenna device. As indicated in FIG. 1, one or both of the first and the second sub-antennas may be array antennas comprising a number of radiation elements 130-140 and 180, which may be of the same or different polarizations.

Also, it is possible to have dual-polarized antenna elements within one and the same sub-antenna.

Each of the sub-antennas 110, 112, also comprises respective and feed networks 120, 175, for distributing signals within each of the sub-antennas.

The radio base station 105 is connected to the antenna device 100 by means of a common main feed network 170, which distributes signals to and from the base station and the sub-antennas. The common main feed network 170 is in turn connected to the radio base station 105 by means of a common feed connection 108, which may be a conventional RF-connection.

Due to the fact that there is a common feed connection 108 and a common feed network 170 between the radio base station 105 and the sub-antennas 110, 112, the base station will perceive and be able to treat the antenna device 100 as one single antenna, which means that no changes need to be introduced in the radio base station.

The common main feed network 170 is connected to the sub-antennas 110, 112, via feeder connections 160, which connect to the feed networks 120, 175 of the first and second sub-antennas respectively.

In the device 100 of the invention, there is also comprised, for at least one of the sub-antennas, a control connection 150, 188, by means of which control and supervision of the sub-antennas may be carried out. In some embodiments, there may also or instead be a control connection 190 to the main feed network 170 of the device.

The control of the sub-antennas which is carried out by means of the control connections 150, 188, 190, can be handled by a control function within the radio base station 105, or, as an alternative, by a separate control function within the system. The use of the control connections will be elaborated upon in more detail later in this description.

A principle behind the antenna device of the invention will now have emerged: a number of sub-antennas 110, 112, are controlled independently to achieve a desired coverage of a cell within a cellular telephony system. The sub-antennas can be identical to one another, or different. The sub-antennas 110, 112, are connected to the radio base station 105 via a common main feed network 170, which means that the radio base station will perceive the sub-antennas as one single antenna. Due to this, no changes need to be made to the base stations, all that needs to be done is to introduce the control means described above, which can be a function separate from the base station, or integrated as a function within the base station.

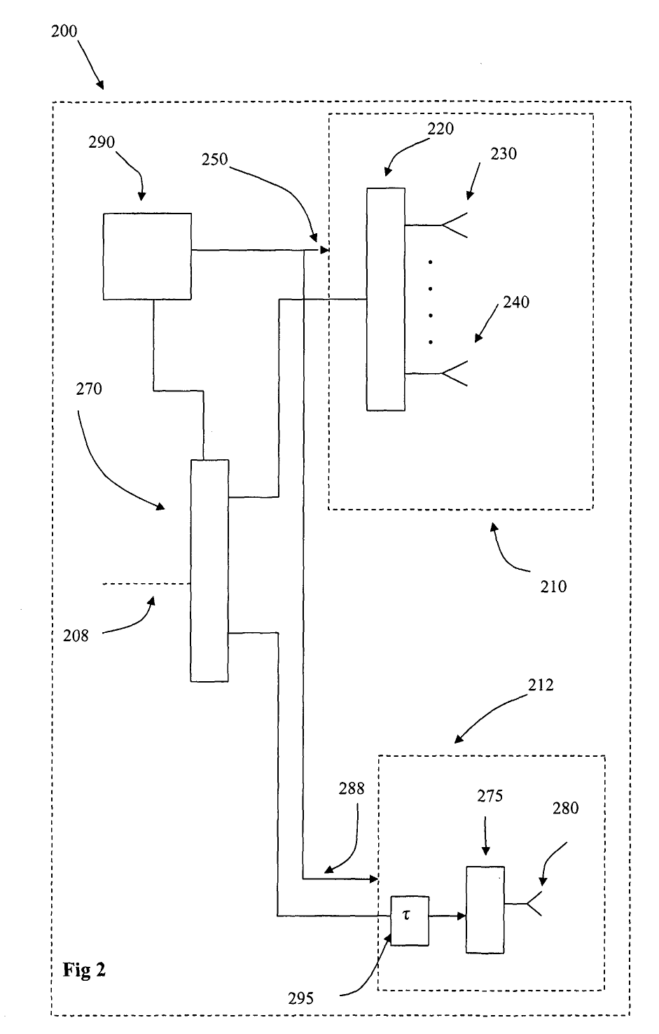

FIG. 2 shows another embodiment of an antenna device 200 of the invention: The antenna device 200 is intended for a radio base station in a mobile cellular telephony network, and in similarity to the embodiment shown previously, the antenna device 200 comprises a first sub-antenna 210 for receiving and transmitting electromagnetic energy in the microwave range. The first sub-antenna 210 is shown within a rectangle drawn with dashed lines.

The antenna device 200 also comprises a first antenna feed network 220 for distributing signals within the first antenna, and a first control connection 250 for the first antenna.

In addition, the antenna device 200 also comprises a second sub-antenna 212 for receiving and transmitting electromagnetic energy in the microwave range, with a second control connection 288 for the second sub-antenna and a second antenna feed network 275 for distributing signals within the second antenna.

The feed networks 220, 275 of the first 210 and second 212 sub-antenna are connected to a common main feed network 270, which can connect them to a radio base station. Each of the sub-antennas 210, 212, can comprise one or more radiating elements 230-240, 280.

In order to handle situations where undesired interaction between the signals from the sub-antennas becomes a problem, the antenna device comprises means 295 for introducing a time delay τ in the signals transmitted from (or received by) one of the sub-antennas, in this case the second sub-antenna 212. The control of this delay is in the example shown in FIG. 2 handled by a separate control function 290, which may also be a function integral to the base station to which the antenna device 200 is connected.

Other possible means of avoiding such interaction may include the use of different polarizations between the sub-antennas, or sufficient spatial separation of the different sub-antennas.

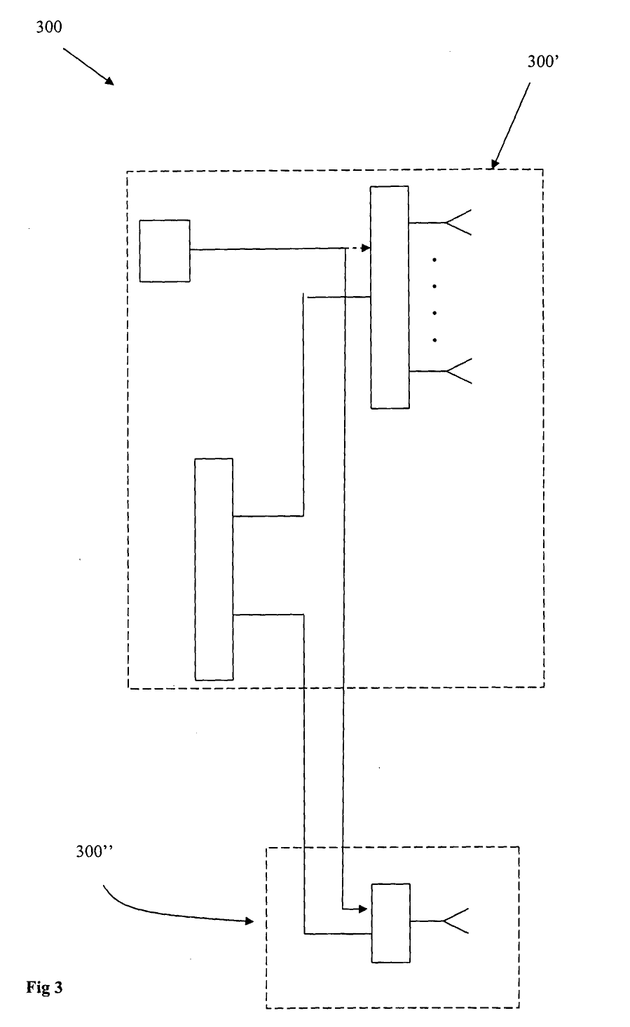

In FIGS. 1 and 2, the antenna devices 100, 200, are shown with the sub-antennas being co-located at one and the same geographical location, i.e. in the vicinity of each other. This is merely an example, FIG. 3 shows another embodiment 300 of the invention, where this is not the case. The system 300 comprises essentially the same components as the system 200 of FIG. 2, for which reason the system 300 will not be described in detail here.

However, the main difference between the systems 200 and 300 is that in the system 300, the sub-antennas are not located in the vicinity of each other. Instead, the sub-antennas, as indicated by the dotted lines, can be located quite far from each other, 300′ and 300″, but still be connected to a common main feed network which connects them to the base station, and with the control connections of the sub-antennas still being used.

The invention is not limited to the examples above, but may be varied freely within the scope of the amended claims. Variations which may be mentioned are for example that the first and the second sub-antennas are of a first and a second respective polarization, which are essentially orthogonal to each other. At least one of the first and second sub-antennas may be an array antenna with at least two radiating elements.

The feed networks of the first and second sub-antennas have been shown consistently as being connected in parallel to the main feed network. However, one of the feed networks of one of the sub-antennas may be equipped with means for distributing RF-signals to and from the other sub-antenna, meaning that the sub-antennas are serially fed from the common main feed network.

The control means of the device can then be used for controlling the power distribution between the first and the second sub-antenna.

In the embodiments where the sub-antennas are connected in parallel to the main feed network, control means 190 connected to the main feed network may in a similar manner be used for controlling the power distribution between the sub-antennas, or some of the other parameters mentioned.

The first and second sub-antennas may be identical to each other with respect to gain and beam width in azimuth, and in elevation as well as other parameters. As an alternative, one of the sub-antennas may differ from the other with respect to antenna gain and/or antenna beam width in azimuth or in elevation or other parameters.

1-16. (canceled)

17. An antenna device for a radio base station in a mobile cellular telephony network, the antenna device comprising:
a first sub-antenna having a first feed network for distributing signals within the first sub-antenna;
a second sub-antenna having a second feed network for distributing signals within the second sub-antenna;
a common main feed network connected to the first and second feed networks and providing the antenna device with a single feed port; and
first control means for controlling at least one of the sub-antennas.

18. The antenna device as recited in claim 17, further comprising second control means for controlling the common main feed network.

19. The antenna device as recited in claim 18, wherein the first and second control means are used for controlling the power distribution between the sub-antennas.

20. The antenna device as recited in claim 17, further comprising means for introducing a time delay (τ) in signals being transmitted or received by at least one of the first and second sub-antennas.

21. The antenna device as recited in claim 17, wherein the first control means includes means for controlling a time delay (τ) in signals being transmitted or received or for electrically steering of one of the sub-antennas which is electrically steerable.

22. The antenna device as recited in claim 17, wherein the first control means includes a first control connection to the first sub-antenna and a second control connection to the second sub-antenna and/or a control connection to the main feed network.

23. The antenna device as recited in claim 17, wherein the first and the second sub-antennas are of a first and a second respective polarization, which are essentially orthogonal to each other.

24. The antenna device as recited in claim 17, wherein at least one of the first and second sub-antennas is an array antenna with at least two radiating elements.

25. The antenna device as recited in claim 17, wherein one of the feed networks of one of the sub-antennas includes means for distributing RF signals to and from the second sub-antenna, so that the sub-antennas may be serially fed from the common main feed network.

26. The antenna device as recited in claim 17, wherein the first and second sub-antennas are identical with respect to gain and beam width in azimuth.

27. The antenna device as recited in claim 17, wherein the first and second sub-antennas are identical with respect to gain and beam width in elevation.

28. The antenna device as recited in claim 17, wherein one of the sub-antennas differs from the other with respect to antenna gain.

29. The antenna device as recited in claim 17, wherein one of the sub-antennas differs from the other with respect to antenna beam width in azimuth.

30. The antenna device as recited in claim 17, wherein one of the sub-antennas differs from the other with respect to antenna beam width in elevation.

31. The antenna device as recited in claim 17, wherein one of the sub-antennas differs from the other with respect to polarization.

32. The antenna device as recited in claim 17, wherein the power distribution between the sub-antennas is equal.
